(19) United States
(12) Patent Application Publication
(10) Pub. No.: US 2012/0197420 A1
(43) Pub. Date: Aug. 2, 2012

(54) SIGNAL PROCESSING DEVICE, SIGNAL PROCESSING METHOD, AND PROGRAM

(76) Inventors: Toshiyuki KUMAKURA, Tokyo (JP); Mototsugu Abe, Kanagawa (JP)

(21) Appl. No.: 13/354,126

(22) Filed: Jan. 19, 2012

(30) Foreign Application Priority Data
Jan. 28, 2011 (JP) 2011-016398

(51) Int. Cl. G06F 17/00

(52) U.S. Cl. 700/94

(57) ABSTRACT

A signal processing device includes a sound collecting unit configured to collect sound, a covering detecting unit configured to detect a covered state of the sound collecting unit on the basis of a resonance frequency and a magnitude of a component of the resonance frequency in a frequency characteristic of an acoustic signal obtained through sound collection performed by the sound collecting unit, and an apparatus control determining unit configured to determine a type of control to be performed on a target apparatus in accordance with the covered state of the sound collecting unit detected by the covering detecting unit.

### BACKGROUND

The present disclosure relates to signal processing devices, signal processing methods, and programs, and particularly relates to a signal processing device, a signal processing method, and a program for realizing voiceless and noncontact input operations.

Various operation methods have been suggested as an operation method for inputting a control instruction for an apparatus (for example, see Japanese Unexamined Patent Application Publication No. 2003-143683).

The above-mentioned publication discloses a method for inputting a control instruction for a mobile phone or the like connected to an earphone by tapping, with a user's finger or the like, a microphone provided in the earphone or the vicinity of the microphone.

### SUMMARY

In recent years, electronic apparatuses have been more diversified. Accordingly, operation methods other than the method described in the above-mentioned publication have been demanded.

It is desirable to realize, as an apparatus operation method other than the method described in the above-mentioned publication, voiceless and noncontact input operations.

According to an embodiment of the present disclosure, there is provided a signal processing device including a sound collecting unit configured to collect sound, a covering detecting unit configured to detect a covered state of the sound collecting unit on the basis of a resonance frequency and a magnitude of a component of the resonance frequency in a frequency characteristic of an acoustic signal obtained through sound collection performed by the sound collecting unit, and an apparatus control determining unit configured to determine a type of control to be performed on a target apparatus in accordance with the covered state of the sound collecting unit detected by the covering detecting unit.

The covering detecting unit may detect whether or not the sound collecting unit is covered, or may detect a degree to which the sound collecting unit is covered.

The covering detecting unit may compare the resonance frequency with a certain threshold and may compare the magnitude of the component of the resonance frequency with a certain threshold, and may detect the covered state of the sound collecting unit in accordance with results of the comparisons.

The covering detecting unit may add resonance frequencies and magnitudes of components of the resonance frequencies in frequency characteristics of the acoustic signal at a plurality of times, and may detect the covered state of the sound collecting unit on the basis of a result of the addition.

The apparatus control determining unit may determine the type of control in accordance with whether or not the sound collecting unit is covered or in accordance with a degree to which the sound collecting unit is covered.

The apparatus control determining unit may determine the type of control in accordance with a period over which the sound collecting unit is covered.

The apparatus control determining unit may determine an amount of control for the type of control in accordance with a degree to which the sound collecting unit is covered.

The sound collecting unit may include a plurality of sound collecting units.

The signal processing device may further include a difference calculating unit configured to calculate a difference in frequency characteristics of acoustic signals obtained by the plurality of sound collecting units. The covering detecting unit may detect the covered states of the plurality of sound collecting units on the basis of the resonance frequency and the magnitude of the component of the resonance frequency in the difference calculated by the difference calculating unit.

The apparatus control determining unit may assign different types of control to similar covered states of the plurality of sound collecting units.

The sound collecting unit may collect sound for a call process. The covering detecting unit may detect the covered state of the sound collecting unit on the basis of a resonance frequency and a magnitude of a component of the resonance frequency in a frequency characteristic of an acoustic signal obtained through sound collection performed for the call process by the sound collecting unit.

The signal processing device may further include a sound recognition processing unit configured to perform a sound recognition process on the acoustic signal obtained through sound collection performed by the sound collecting unit. The apparatus control determining unit may determine the type of control in accordance with the covered state of the sound collecting unit detected by the covering detecting unit and a result of the sound recognition process performed by the sound recognition processing unit.

According to an embodiment of the present disclosure, there is provided a signal processing method for a signal processing device. The signal processing method includes collecting, with a sound collecting unit, sound; detecting, with a covering detecting unit, a covered state of the sound collecting unit on the basis of a resonance frequency and a magnitude of a component of the resonance frequency in a frequency characteristic of an acoustic signal obtained through sound collection; and determining, with an apparatus control determining unit, a type of control to be performed on a target apparatus in accordance with the detected covered state of the sound collecting unit.

According to an embodiment of the present disclosure, there is provided a program that causes a computer to execute a process. The process includes collecting sound, detecting a covered state of a sound collecting unit on the basis of a resonance frequency and a magnitude of a component of the resonance frequency in a frequency characteristic of an acoustic signal obtained through the collecting sound, and determining a type of control to be performed on a target apparatus in accordance with the detected covered state of the sound collecting unit.

According to an embodiment of the present disclosure, a covered state of a sound collecting unit is detected on the basis of a resonance frequency and a magnitude of a component of the resonance frequency in a frequency characteristic of an acoustic signal obtained through sound collection, and a type of control to be performed on a target apparatus is determined in accordance with the detected covered state of the sound collecting unit.

According to the embodiments of the present disclosure, a signal can be processed. In particular, a voiceless and noncontact input operation can be realized as a method for operating an apparatus.

### BRIEF DESCRIPTION OF THE DRAWINGS

FIG. 1 is a block diagram illustrating an exemplary configuration of a control device according to a first embodiment of the present disclosure;

FIG. 2 is a block diagram illustrating an exemplary configuration of a covering detecting unit illustrated in FIG. 1;

FIGS. 3A and 3B are diagrams illustrating a principle of an operation of detecting a covered state;

FIG. 4 is a diagram illustrating an example of a frequency characteristic of an acoustic signal input in a covered state;

FIGS. 5A and 5B are diagrams illustrating an example of a method for determining a covered state;

FIGS. 6A to 6C are diagrams illustrating another example of a method for determining a covered state;

FIGS. 7A to 7C are diagrams illustrating a difference in frequency characteristics of acoustic signals caused by a difference in coverage;

FIG. 8 is a block diagram illustrating an exemplary configuration of an apparatus control determining unit illustrated in FIG. 1;

FIG. 9 is a diagram illustrating an example of a method for determining a type of control to be performed on an apparatus;

FIG. 10 is a diagram illustrating another example of a method for determining a type of control to be performed on an apparatus;

FIG. 11 is a flowchart illustrating an example of a procedure of a control process;

FIG. 12 is a flowchart illustrating an example of a procedure of a covered state detection process;

FIG. 13 is a flowchart illustrating an example of a procedure of a type-of-control determination process;

FIG. 14 is a block diagram illustrating an exemplary configuration of a control device according to a second embodiment of the present disclosure;

FIG. 15 is a block diagram illustrating an exemplary configuration of a covering detecting unit illustrated in FIG. 14;

FIGS. 16A to 16C are diagrams illustrating an example of signal processing for analyzing a frequency characteristic;

FIG. 17 is a flowchart illustrating another example of a procedure of a control process;

FIG. 18 is a flowchart illustrating another example of a procedure of a covered state detection process;

FIG. 19 is a block diagram illustrating an exemplary configuration of a portable music player according to a third embodiment including the control device according to one of the first and second embodiments;

FIG. 20 is a flowchart illustrating still another example of a procedure of a control process;

FIG. 21 is a flowchart illustrating another example of a procedure of a type-of-control determination process;

FIG. 22 is a block diagram illustrating an exemplary configuration of a mobile phone according to a fourth embodiment including the control device according to one of the first and second embodiments;

FIG. 23 is a flowchart illustrating still another example of a procedure of a control process;

FIG. 24 is a flowchart illustrating still another example of a procedure of a type-of-control determination process; and

FIG. 25 is a block diagram illustrating an exemplary configuration of a personal computer according to a fifth embodiment of the present disclosure.

### DETAILED DESCRIPTION OF EMBODIMENTS

Hereinafter, embodiments of the present disclosure will be described. The description will be given in the following order.

1. First embodiment (control device)

2. Second embodiment (control device)

3. Third embodiment (portable music player)

4. Fourth embodiment (mobile phone)

5. Fifth embodiment (personal computer)

### 1. First Embodiment

### Control Device

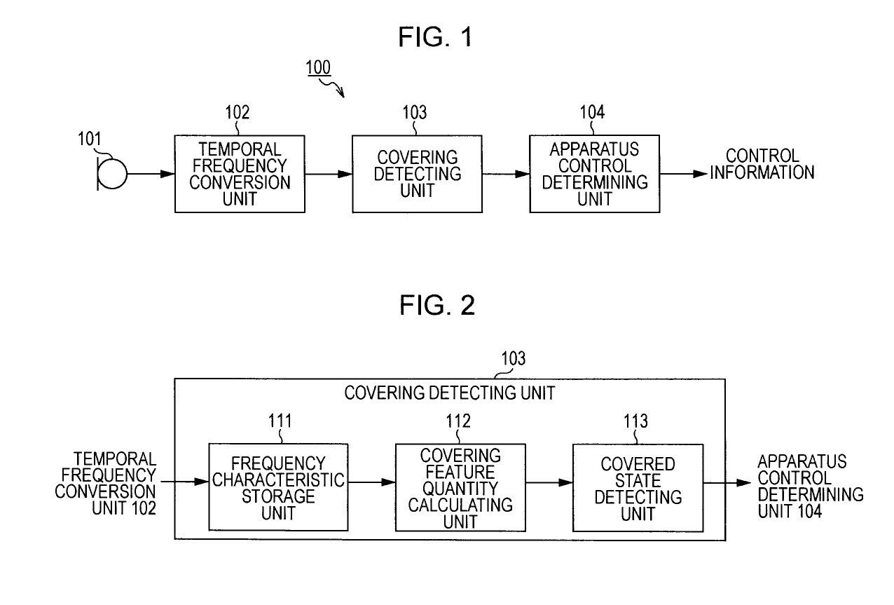

FIG. 1 illustrates the configuration of a control device 100 according to a first embodiment of the present disclosure.

The control device 100 illustrated in FIG. 1 is a device that controls an electronic apparatus (not illustrated), and outputs control information, such as a command or data for controlling a target electronic apparatus, in response to an instruction provided from a user or the like.

As illustrated in FIG. 1, the control device 100 includes an acoustic signal input unit 101. The user covers the acoustic signal input unit 101 and the vicinity thereof with his/her hand or the like, thereby inputting an instruction for the electronic apparatus to the control device 100.

The acoustic signal input unit 101 includes a sensor, which is constituted by a microphone or the like. The acoustic signal input unit 101 collects ambient acoustic signals using the sensor, and converts the acoustic signals into electric signals.

An acoustic signal includes, for example, information about vibration of various objects or spaces, such as a sound, a voice, a noise, or a vibration. The acoustic signal input unit 101 detects an acoustic signal (i.e., vibration of various objects or spaces) generated in a surrounding region in a certain range.

Although the details will be described below, when the user covers the acoustic signal input unit 101 and the vicinity thereof with his/her hand, for example, a small space is formed between the hand (something covering) and the acoustic signal input unit 101, the transmission function of the acoustic signal input unit 101 changes due to the existence of the small space (for example, the position, shape, and size of the small space, and the material, shape, and angle of something covering), and a resonance point is observed in a collected acoustic signal.

The control device 100 analyzes the frequency component of an electric signal obtained by converting the acoustic signal, thereby detecting a change in the transmission function of the acoustic signal input unit 101 (generation of a resonance point), detects a state where the user covers the acoustic signal input unit 101 and the vicinity thereof on the basis of the change in the transmission function, and outputs control information based on the coverage of the acoustic signal input unit 101.

As illustrated in FIG. 1, the control device 100 includes a temporal frequency conversion unit 102, a covering detecting unit 103, and an apparatus control determining unit 104, in addition to the acoustic signal input unit 101. The temporal frequency conversion unit 102 performs frequency conversion on an electric signal output from the acoustic signal input unit 101 (an electric signal obtained by converting an acoustic signal (input sound) collected by the acoustic signal input unit 101) using an arbitrary method, such as Fourier transform, generates a frequency characteristic (power spectrum) of the electric signal, and supplies the frequency characteristic to the covering detecting unit 103.

The covering detecting unit 103 analyzes the power spectrum, which is obtained through conversion of the acoustic signal performed by the temporal frequency conversion unit 102, determines a state where the acoustic signal input unit 101 is covered (covered state) on the basis of characteristics (for example, frequency, magnitude, etc.) of a resonance point observed in the power spectrum, and supplies the determination result (information representing the covered state) to the apparatus control determining unit 104.

The apparatus control determining unit 104 determines the type of control to be performed on an electronic apparatus (not illustrated) in accordance with the determination result (information representing the covered state of the acoustic signal input unit 101) supplied from the covering detecting unit 103, and outputs control information (command, data, etc.) regarding the determined type of control to the electronic apparatus.

With the above-described configuration, the user can input an instruction for the electronic apparatus to the control device 100 simply by covering the acoustic signal input unit 101 and the vicinity thereof, without using his/her voice and without touching the control device 100 (the acoustic signal input unit 101 or the like). That is, the control device 100 is capable of realizing a voiceless and noncontact input operation.

### Covering Detecting Unit

FIG. 2 is a block diagram illustrating an exemplary configuration of the covering detecting unit 103 illustrated in FIG. 1. As illustrated in FIG. 2, the covering detecting unit 103 includes a frequency characteristic storage unit 111, a covering feature quantity calculating unit 112, and a covered state detecting unit 113.

The frequency characteristic storage unit 111 includes an arbitrary storage medium, such as a hard disk, a flash memory, or a random access memory (RAM), and stores the frequency characteristic (power spectrum) of input sound supplied from the temporal frequency conversion unit 102. The frequency characteristic storage unit 111 supplies a power spectrum stored therein to the covering feature quantity calculating unit 112 at a certain timing or in response to a request from the covering feature quantity calculating unit 112.

The covering feature quantity calculating unit 112 analyzes the power spectrum obtained from the frequency characteristic storage unit 111.

Now, a covered state and the feature thereof will be described.

For example, when a user covers the acoustic signal input unit 101 and the vicinity thereof with his/her hand or the like, a small space is formed between the hand (something covering) and the acoustic signal input unit 101. This small space may not be a closed space that is completely separated from the surrounding space, and may be a space that is partially separated from the surrounding space by a hand or the like.

With the existence of this small space, the transmission function of the acoustic signal input unit 101 changes, and a resonance point is observed in the power spectrum of the input sound.

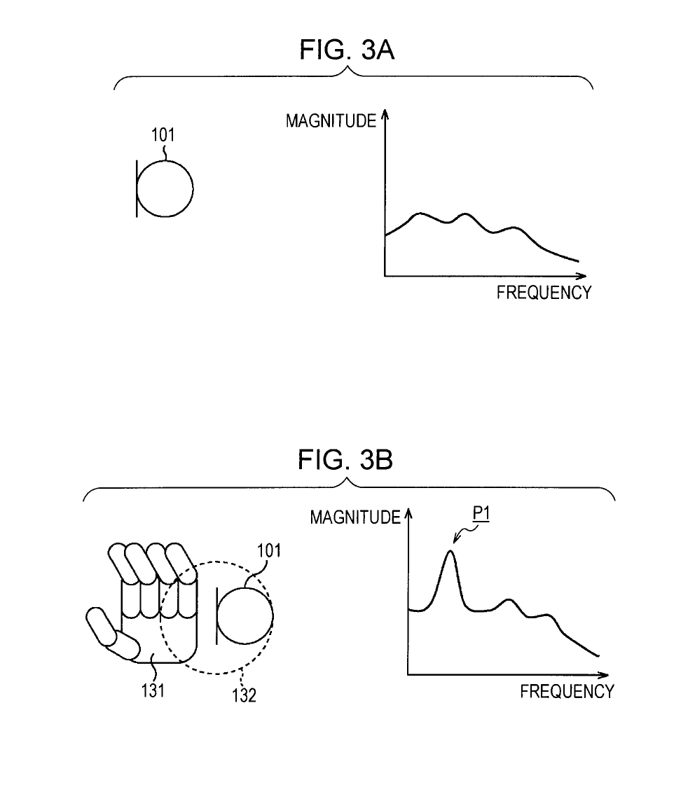

FIGS. 3A and 3B are diagrams illustrating a principle of an operation of detecting a covered state. For example, as illustrated on the left in FIG. 3A, it is assumed that the acoustic signal input unit 101 and the vicinity thereof (sound collection range) are not covered. In this state, no resonance point is detected in the power spectrum of the input sound supplied from the acoustic signal input unit 101, as shown in the graph illustrated on the right in FIG. 3A.

On the other hand, as illustrated on the left in FIG. 3B, for example, when a user covers the acoustic signal input unit 101 and the vicinity thereof (sound collection range) with a hand 131, a small space 132 is formed between the hand 131 and the acoustic signal input unit 101. In this state, the spectrum at a certain frequency becomes very high with respect to the other frequencies in the power spectrum of the input sound supplied from the acoustic signal input unit 101, as shown in the graph illustrated on the right in FIG. 3B. That is, a peak P1 of the spectrum is observed. The peak P1 is a resonance point. Hereinafter, the peak P1 will be also referred to as a resonance point P1.

Referring back to FIG. 2, the covering feature quantity calculating unit 112 calculates the feature quantity of the resonance point P1. The covering feature quantity calculating unit 112 supplies the calculated feature quantity to the covered state detecting unit 113.

The covered state detecting unit 113 determines the covered state of the acoustic signal input unit 101 on the basis of the feature quantity supplied from the covering feature quantity calculating unit 112, and supplies the determination result, that is, information representing the covered state (covered state information) to the apparatus control determining unit 104.

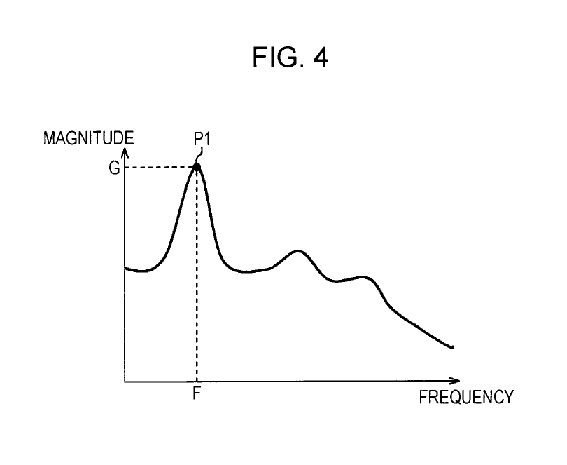

For example, the covering feature quantity calculating unit 112 calculates, as a feature quantity, the frequency (resonance frequency) F and the magnitude G at the resonance point P1 observed in the power spectrum, as illustrated in FIG. 4.

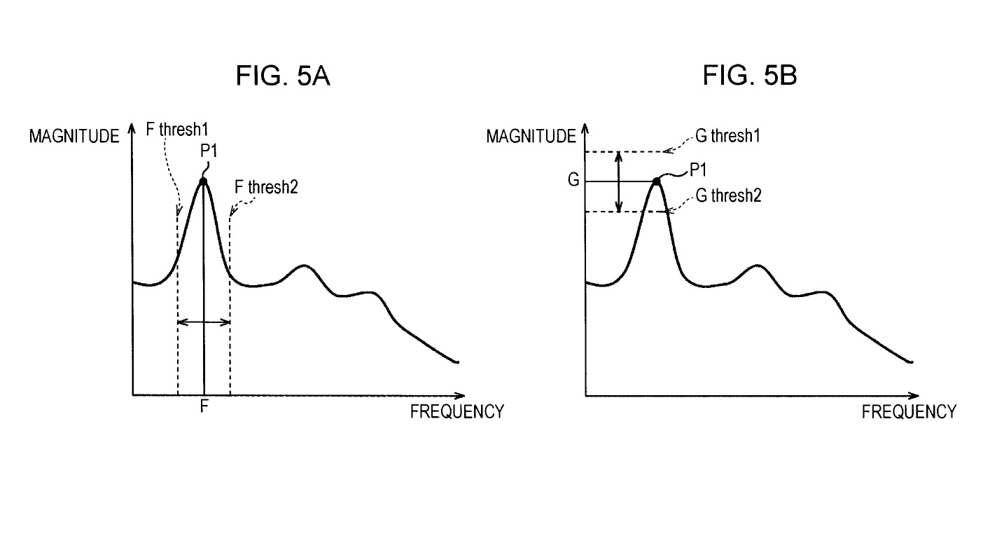

On the other hand, when the frequency F at the resonance point P1 is between thresholds F thresh1 and F thresh2 as illustrated in FIG. 5A and when the magnitude G of the spectrum at the resonance point P1 is between thresholds G thresh1 and G thresh2 as illustrated in FIG. 5B, the covered state detecting unit 113 determines that the acoustic signal input unit 101 is covered. Also, the covered state detecting unit 113 determines the coverage on the basis of the value of the magnitude G.

The coverage indicates to what degree the acoustic signal input unit 101 is covered by something covering, such as a user's hand. The magnitude G of the spectrum at the resonance point P1 changes in accordance with the position, shape, and size of the small space, and the material, position, angle, and shape of something covering, for example. That is, the magnitude G at the resonance point P1 changes in accordance with the way in which the acoustic signal input unit 101 is covered. For example, if the user covers, with his/her hand or the like, the acoustic signal input unit 101 over a wider region at a position closer to the acoustic signal input unit 101 (covers the acoustic signal input unit 101 more tightly), the magnitude G of the spectrum at the resonance point P1 becomes large. Thus, as the value of the magnitude G increases, the covered state detecting unit 113 outputs a value indicating that the acoustic signal input unit 101 is tightly covered.

For example, the covered state detecting unit 113 outputs a value “0” serving as covered state information when the magnitude G is equal to the threshold G thresh2, and outputs a value closer to “1” as the magnitude G becomes closer to the threshold G thresh1.

According to the description given above, the coverage is determined by determining the frequency F and the magnitude G of the spectrum at the resonance point P1 with respect to the thresholds. Alternatively, other methods may be used to detect a covered state.

For example, instead of the spectrum, a parameter representing an outline of the spectrum, such as a linear prediction coefficient, cepstrum, or mel-frequency cepstral coefficient (MFCC), may be used.

Also, for example, the coverage may be determined on the basis of the shape of the spectrum of frequency components at the vicinity of the peak (resonance point P1) of the power spectrum of input sound.

For example, the covering feature quantity calculating unit 112 may calculate, as a feature quantity, the shape of the spectrum of frequency components at the vicinity of the peak (resonance point P1) of the power spectrum of input sound, and the covered state detecting unit 113 may compare the shape with a model case to determine the coverage.

In this case, the for example, the covered state detecting unit 113 may compare the spectrum in a certain frequency band including the resonance point P1 supplied from the covering feature quantity calculating unit 112 with the spectrum in the certain frequency band in a case where the acoustic signal input unit 101 is covered with a certain coverage (spectrum of a model case), may determine the value of covered state information (for example, a value “0” or “1”) on the basis of the approximation therebetween, and may output the value.

In this way, a covered state may be determined more accurately. The number of model cases is not limited. As the number of model cases increases, a covered state may be determined more accurately.

Also, for example, many spectra in a state where the acoustic signal input unit 101 is covered and many spectra in a state where the acoustic signal input unit 101 is not covered may be collected, and a statistical identifier, such as a neural network, support vector machine, or Gaussian mixture models (GMM), may be used. Also in a statistical identification method, a covered state can be reflected in a determination result by associating individual states with respective values, for example, by associating a tightly covered state with “1”, a loosely covered state with “0.5”, and a non-covered state with “−1”.

In this way, the covered state detecting unit 113 is capable of reflecting various conditions, such as the individual characteristic and a usage environment of an apparatus, in the determination of a covered state, and performing more accurate determination.

In a case where calculation of a covering feature quantity and detection of a covered state are performed using the spectrum at only a certain sampling time, as in the example described above, the frequency characteristic storage unit 111 may be omitted.

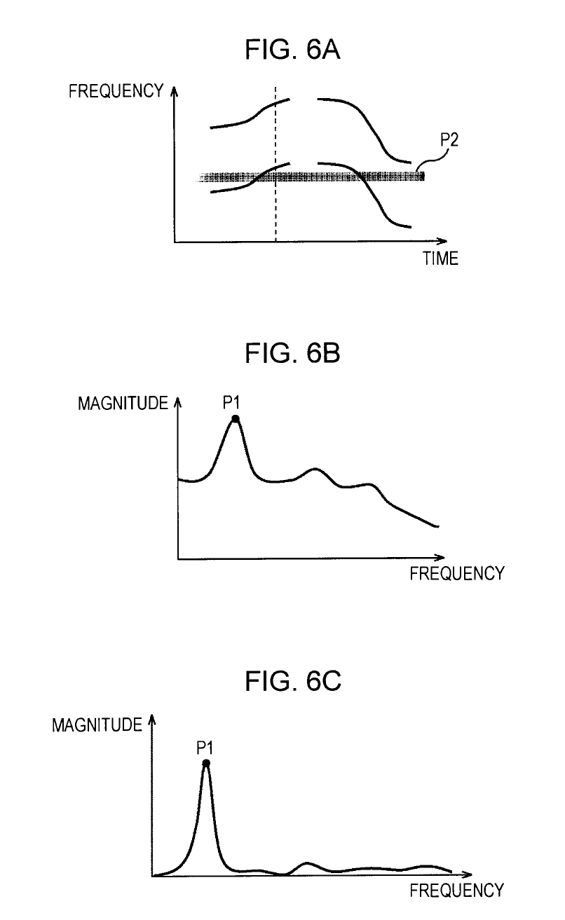

Alternatively, the frequency characteristic storage unit 111 may store spectra at a plurality of sampling times. In that case, the covering feature quantity calculating unit 112 may calculate a covering feature quantity using the plurality of spectra (at sampling times) stored in the frequency characteristic storage unit 111. That is, the covering feature quantity calculating unit 112 may calculate a feature quantity regarding the peak (resonance point P1) on the basis of the spectrogram illustrated in FIG. 6A, for example.

The spectrogram illustrated in FIG. 6A shows a set of spectra at a plurality of times. For example, if the acoustic signal input unit 101 is covered with a user's hand or the like at a certain time indicated by a broken line in FIG. 6A, a peak P1 is observed in the spectrum at the time, as illustrated in FIG. 6B.

If this covered state continues, the continuation of the peak P1 is represented by a band P2 in the spectrogram over that period, as illustrated in FIG. 6A. Thus, by adding frequency characteristics stored in the frequency characteristic storage unit 111 in a time direction, the magnitude can be emphasized when the frequency slightly changes, and the magnitude can be suppressed to be small when the frequency changes, as illustrated in FIG. 6C. That is, the magnitude of the spectrum at the peak (resonance point P1) can be emphasized. Accordingly, the determination of a covered state can be performed more easily by the covered state detecting unit 113.

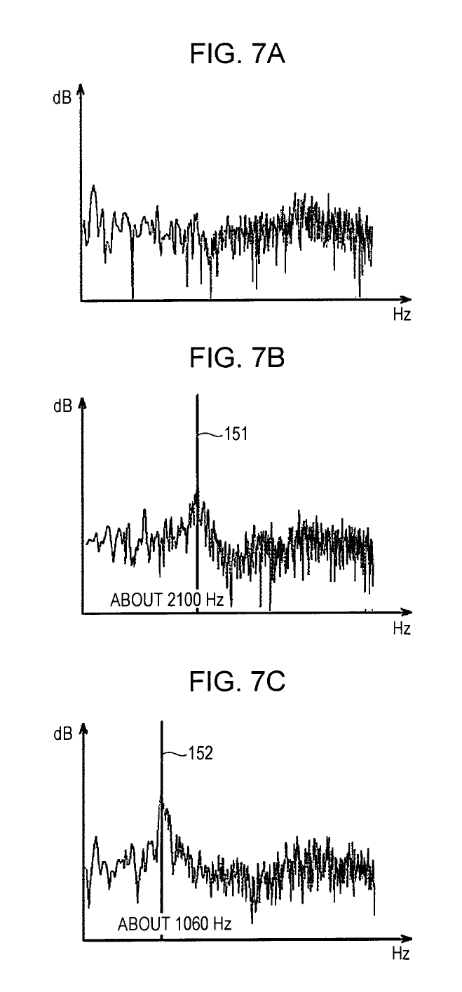

Typically, not only the magnitude G of the spectrum but also the resonance frequency F change in accordance with the coverage. FIGS. 7A to 7C illustrate differences in frequency characteristic of an acoustic signal according to differences in the coverage. The graph in FIG. 7A illustrates an example of the frequency characteristic in a state where the acoustic signal input unit 101 is not covered (normal state).

The graph in FIG. 7B illustrates an example of the frequency characteristic in a state where the acoustic signal input unit 101 is slightly covered (the coverage is low). In this case, a peak is observed at about 2100 Hz, as indicated by a line 151. That is, the resonance frequency F is about 2100 Hz.

The graph in FIG. 7C illustrates an example of the frequency characteristic in a state where the acoustic signal input unit 101 is tightly covered (the coverage is high). In this case, a peak is observed at about 1060 Hz, as indicated by a line 152. That is, the resonance frequency F is about 1060 Hz.

In this way, when the covered state (coverage) changes, not only the magnitude G of the spectrum at the resonance point but also the resonance frequency F change. Thus, the covered state detecting unit 113 may determine the covered state using a change in the resonance frequency F.

### Apparatus Control Determining Unit

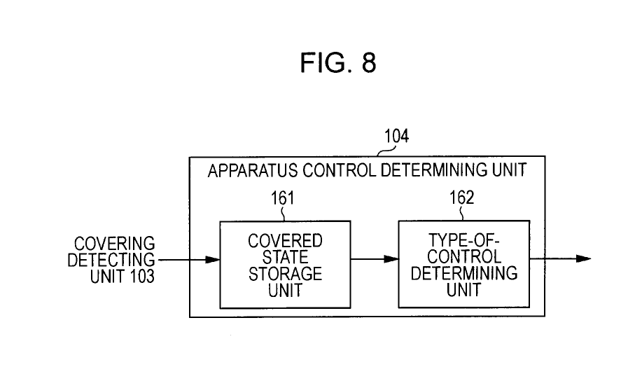

FIG. 8 is a block diagram illustrating an exemplary configuration of the apparatus control determining unit 104 illustrated in FIG. 1. As illustrated in FIG. 8, the apparatus control determining unit 104 includes a covered state storage unit 161 and a type-of-control determining unit 162.

The covered state storage unit 161 includes an arbitrary storage medium, such as hard disk, a flash memory, or a RAM, and stores covered state information supplied from the covering detecting unit 103. The covered state storage unit 161 supplies the covered state information stored therein to the type-of-control determining unit 162 at a certain timing or in response to a request from the type-of-control determining unit 162.

When obtaining the covered state information from the covered state storage unit 161, the type-of-control determining unit 162 determines the type of control to be performed on the electronic apparatus (not illustrated) corresponding to a user operation on the basis of a value or the like included in the covered state information, and outputs control information (command, data, etc.) regarding the determined type of control.

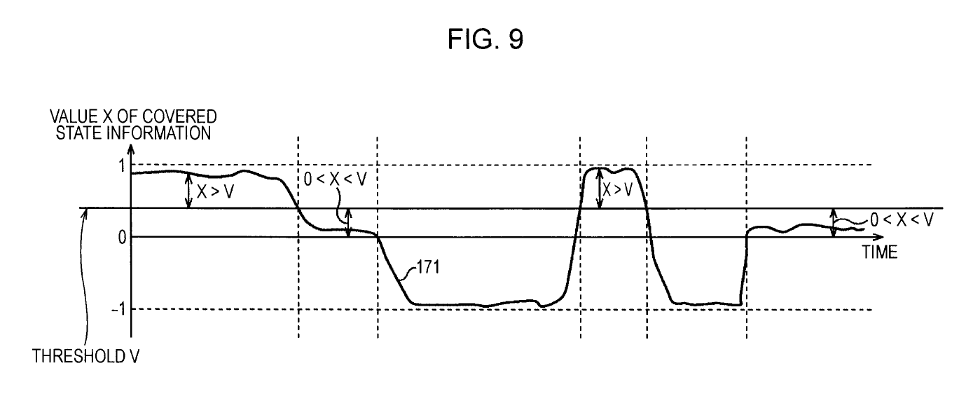

FIG. 9 is a diagram illustrating an example of changes along a time axis of the output of the covering detecting unit 103 (covered state information). The curved line 171 illustrated in FIG. 9 indicates the value of the covered state information.

The type-of-control determining unit 162 sets a certain threshold V for the covered state information, and determines, using the threshold V, whether or not the acoustic signal input unit 101 is covered. If the value of the covered state information is larger than the threshold V (or equal to or larger than the threshold V), the type-of-control determining unit 162 determines that the acoustic signal input unit 101 is covered. In other words, if the value of the covered state information is equal to or smaller than the threshold V (or smaller than the threshold V), the type-of-control determining unit 162 determines that the acoustic signal input unit 101 is not covered.

Then, the type-of-control determining unit 162 determines the type of control to be performed on the basis of the determination result, and outputs control information regarding the determined type of control. Accordingly, the type-of-control determining unit 162 is capable of outputting control information in accordance with whether or not the acoustic signal input unit 101 is covered.

Alternatively, a plurality of thresholds may be provided for covered state information, and the type-of-control determining unit 162 may determine not only whether or not the acoustic signal input unit 101 is covered but also the coverage. For example, in the example illustrated in FIG. 9, it may be determined that the acoustic signal input unit 101 is tightly covered (the coverage is high) if the value X of the covered state information is larger than the threshold V (X>V), it may be determined that the acoustic signal input unit 101 is loosely covered (the coverage is low) if V≧X>0, and it may be determined that the acoustic signal input unit 101 is not covered if 0≧X.

In this way, the type-of-control determining unit 162 is capable of determining the type of control to be performed more diversely on the basis of the covered state information.

Of course, the type-of-control determining unit 162 may set more thresholds and determine more states. Also, the type-of-control determining unit 162 may use the value X itself of the covered state information or a value that is uniquely obtained from the value X of the covered state information as the coverage, and may output control information including the coverage.

In these cases, for example, the type-of-control determining unit 162 may use the value X of the covered state information as the coverage, generate control information for controlling the electronic apparatus at the control quantity in accordance with the coverage, and output the generated control information. That is, the control information includes not only the type of control (which type of control is to be performed) but also the control quantity corresponding to the coverage (to what degree control is to be performed).

In this way, the type-of-control determining unit 162 is capable of determining the type of control to be performed more diversely on the basis of the covered state information.

Furthermore, the type-of-control determining unit 162 may determine the type of control to be performed in accordance with the pattern of changes in the value X of the covered state information (the history of the covered state or coverage).

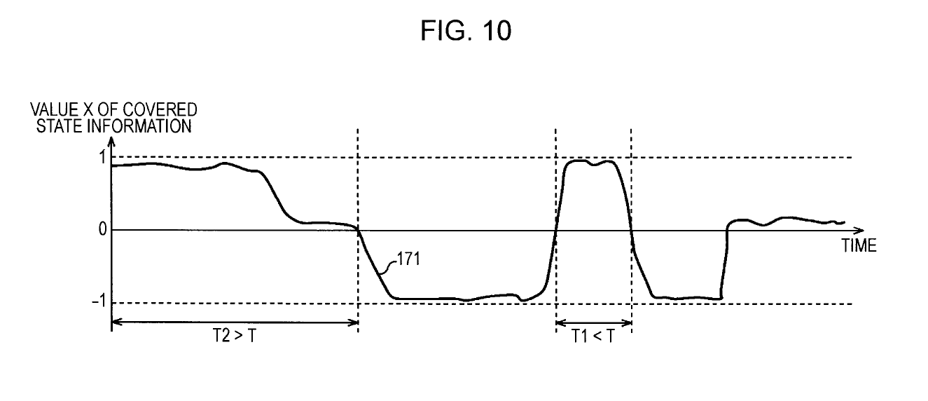

Also, the type-of-control determining unit 162 may determine the type of control to be performed on the basis of the length of the period over which the acoustic signal input unit 101 is covered (covered period), the length being obtained on the basis of the covered state information, as illustrated in FIG. 10, for example.

The curved line 171 illustrated in FIG. 10 indicates the value of the covered state information, as in FIG. 9. For example, the type-of-control determining unit 162 may set a time threshold T, and may determine the type of control to be performed on the basis of whether or not the covered period (the period over which the value X of the covered state information is larger than a value “0”) is longer than the time threshold T, as illustrated in FIG. 10.

In FIG. 10, for example, the length of the period T2 over which the acoustic signal input unit 101 is covered is longer than the time threshold T, and the period T1 over which the acoustic signal input unit 101 is covered is shorter than the threshold T. The type-of-control determining unit 162 may assign different types of control to the periods T1 and T2.

In this way, the type-of-control determining unit 162 is capable of determining the type of control to be performed in accordance with the length of the period over which the acoustic signal input unit 101 is covered.

Alternatively, the type-of-control determining unit 162 may provide a plurality of time thresholds T, and may determine the type of control to be performed in accordance with the relationship in length between each threshold and the length of a period over which the acoustic signal input unit 101 is covered. In this way, the type-of-control determining unit 162 is capable of determining the type of control to be performed more diversely on the basis of the length of the period over which the acoustic signal input unit 101 is covered. Of course, as in the case illustrated in FIG. 9, the length of the period over which the acoustic signal input unit 101 is covered may correspond to a control quantity.

Furthermore, the type-of-control determining unit 162 may determine the type of control to be performed in accordance with the pattern of changes in the length of the period over which the acoustic signal input unit 101 is covered (the history of the length of the period).

Also, the above-described type-of-control determination methods may be combined. Furthermore, a method other than the above-described type-of-control determination methods may be combined. For example, the type-of-control determining unit 162 may determine the type of control to be performed in accordance with the time when it is determined that the acoustic signal input unit 101 is covered, or the position of the control device 100.

In this way, the type-of-control determining unit 162 is capable of determining the type control to be performed more diversely.

### Procedure of Control Process

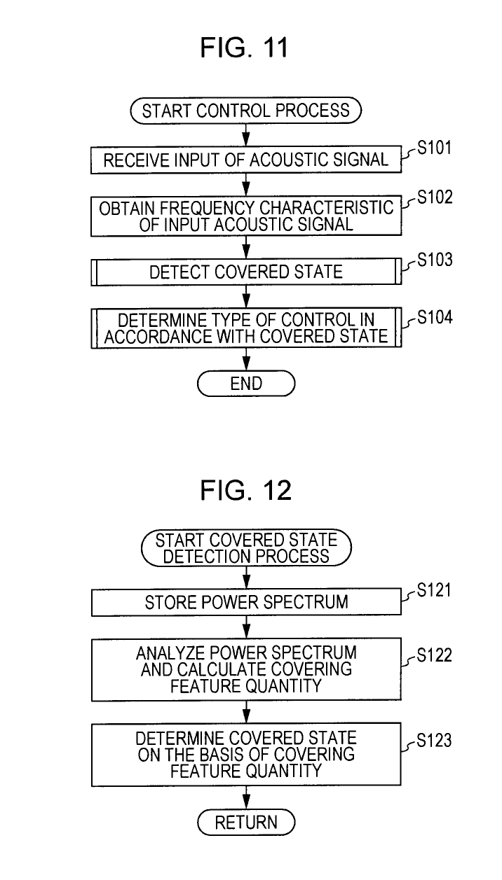

Next, an example of the procedure of a control process performed by the control device 100 will be described with reference to the flowchart illustrated in FIG. 11.

After the control process has started, the acoustic signal input unit 101 of the control device 100 receives an acoustic signal input thereto in step S101. In step S102, the temporal frequency conversion unit 102 performs temporal frequency conversion, such as Fourier transform, on the acoustic signal input in step S101, thereby obtaining the frequency characteristic (power spectrum) of the acoustic signal (input sound).

In step S103, the covering detecting unit 103 detects the covered state of the acoustic signal input unit 101 based on a user operation or the like, by using the power spectrum generated in step S102. In step S104, the apparatus control determining unit 104 determines the type of control to be performed on the target electronic apparatus in accordance with the covered state detected (determined) in step S103 (determines the type of control corresponding to the operation performed by the user (user instruction)), and outputs control information regarding the determined type of control.

After step S104, the control device 100 ends the control process. The control device 100 repeatedly performs such a control process. Actually, the individual steps in the control process are appropriately performed in parallel. For example, in parallel to the execution of step S102 that is performed after step S101, the next control process is started, and step S101 (input of an acoustic signal at the next sampling time) is performed.

### Procedure of Covered State Detection Process

Next, an example of the procedure of the covered state detection process, which is performed by the covering detecting unit 103 in step S103 in FIG. 11, with reference to the flowchart illustrated in FIG. 12.

After the covered state detection process has started, in step S121, the frequency characteristic storage unit 111 stores the power spectrum calculated in step S102 in FIG. 11. In step S122, the covering feature quantity calculating unit 112 analyzes the power spectrum stored in the frequency characteristic storage unit 111, and calculates a covering feature quantity representing the feature of the power spectrum. For example, the frequency F and the magnitude G of the spectrum at a peak (resonance point) are calculated as a covering feature quantity.

In a case where the covering feature quantity calculating unit 112 calculates a covering feature quantity using only the power spectrum of single sampling in step S122, step S121 may be skipped, and step S122 may be performed just after the power spectrum is calculated in step S102 in FIG. 11. Also, in a case where the covering feature quantity calculating unit 112 calculates a covering feature quantity using the power spectra of a plurality of samplings in step S122, step S122 may be performed after step S121 has been performed a certain number of times (a plurality of times).

In step S123, the covered state detecting unit 113 determines the covered state of the acoustic signal input unit 101 (the type of user operation) on the basis of the covering feature quantity calculated in step S122, and outputs covered state information representing the covered state to the apparatus control determining unit 104.

After step S123, the covering detecting unit 103 ends the covered state detection process, the process returns to step S103 in FIG. 11, and the process is performed from step S104.

### Procedure of Type-of-Control Determination Process

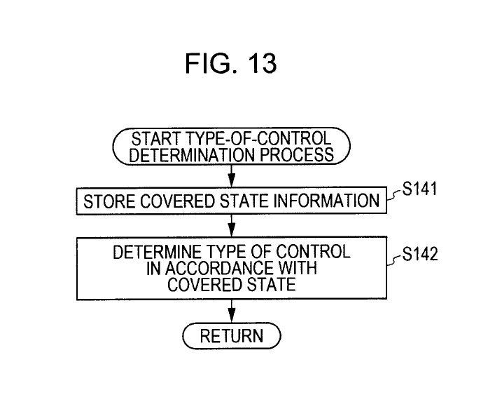

Next, an example of the procedure of the type-of-control determination process performed by the apparatus control determining unit 104 in step S104 in FIG. 11 will be described with reference to the flowchart illustrated in FIG. 13.

After the type-of-control determination process has started, in step S141, the covered state storage unit 161 stores the covered state information generated in step S123 in FIG. 12. In step S142, the type-of-control determining unit 162 determines the type of control to be performed on the electronic apparatus on the basis of the covered state of the acoustic signal input unit 101 indicated by the covered state information stored in the covered state storage unit 161.

In a case where the type-of-control determining unit 162 determines the type of control to be performed on the basis of only the covered state information about single sampling in step S142, step S141 may be skipped, and step S142 may be performed just after the covered state information is generated in step S123 in FIG. 12. Also, in a case where the type-of-control determining unit 162 determines the type of control to be performed using the covered state information about a plurality of samplings in step S142, step S142 may be performed after step S141 has been performed a certain number of times (a plurality of times).

After step S142 has ended, the apparatus control determining unit 104 ends the type-of-control determination process, the process returns to step S104 in FIG. 11, and the control process ends.

As described above, the control device 100 performs the individual processes. Accordingly, the user can input an instruction for the electronic apparatus to the control device 100 simply by covering the acoustic signal input unit 101 and the vicinity thereof, without using his/her voice and without touching the control device 100 (the acoustic signal input unit 101 or the like). That is, the control device 100 is capable of realizing a voiceless and noncontact input operation.

### 2. Second Embodiment

### Control Device

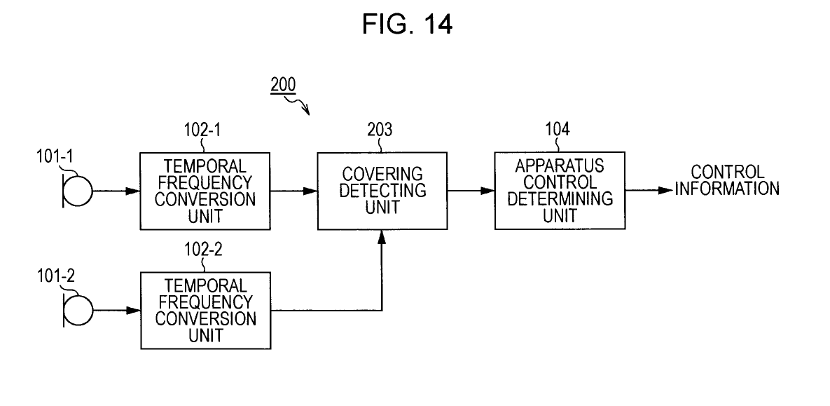

A plurality of acoustic signal input units 101 may be provided. FIG. 14 illustrates the configuration of a control device 200 according to a second embodiment of the present disclosure.

The control device 200 illustrated in FIG. 14 is a device similar to the control device 100 illustrated in FIG. 1. The control device 200 receives an operation of covering an acoustic signal input unit performed by a user or the like, generates control information about the type of control specified by a user instruction, and outputs the control information to a target electronic apparatus. The control device 200 has a configuration basically similar to the configuration of the control device 100, but is different from the control device 100 in having two acoustic signal input units 101 (acoustic signal input unit 101-1 and acoustic signal input unit 101-2).

Each of the acoustic signal input units 101-1 and 101-2 has a sensor similar to the sensor of the acoustic signal input unit 101 of the control device 100, and converts a collected acoustic signal into an electric signal. The acoustic signal input units 101-1 and 101-2 are placed close to each other so that both of them are capable of collecting the substantially same acoustic signal when not being covered by a user or the like. However, the acoustic signal input units 101-1 and 101-2 are placed at a distance from each other so that a user or the like can cover each of them separately.

Hereinafter, when it is not necessary to distinguish the acoustic signal input units 101-1 and 101-2 from each other, they will be referred to as acoustic signal input units 101.

As illustrated in FIG. 14, the control device 200 includes two temporal frequency conversion units 102 (temporal frequency conversion unit 102-1 and temporal frequency conversion unit 102-2). The temporal frequency conversion unit 102-1 performs frequency conversion on an electric signal output from the acoustic signal input unit 101-1 (electric signal obtained by converting an acoustic signal (input sound) collected by the acoustic signal input unit 101-1) by using an arbitrary method, such as Fourier transform, and generates the frequency characteristic (power spectrum) of the electric signal. The temporal frequency conversion unit 102-2 performs frequency conversion on an electric signal output from the acoustic signal input unit 101-2 (electric signal obtained by converting an acoustic signal (input sound) collected by the acoustic signal input unit 101-2) by using an arbitrary method, such as Fourier transform, and generates the frequency characteristic (power spectrum) of the electric signal.

The control device 200 includes a covering detecting unit 203 instead of the covering detecting unit 103 of the control device 100. That is, the control device 200 includes the acoustic signal input units 101-1 and 101-2, the temporal frequency conversion units 102-1 and 102-2, the covering detecting unit 203, and the apparatus control determining unit 104.

The covering detecting unit 203 is a processing unit that is basically similar to the covering detecting unit 103 of the control device 100. Unlike the covering detecting unit 103, the covering detecting unit 203 obtains the outputs (power spectra) of the temporal frequency conversion units 102-1 and 102-2. The covering detecting unit 203 calculates the difference between the inputs (power spectra), calculates a covering feature quantity on the basis of the value of the difference (difference value), determines a covered state, and outputs covered state information to the apparatus control determining unit 104.

### Covering Detecting Unit

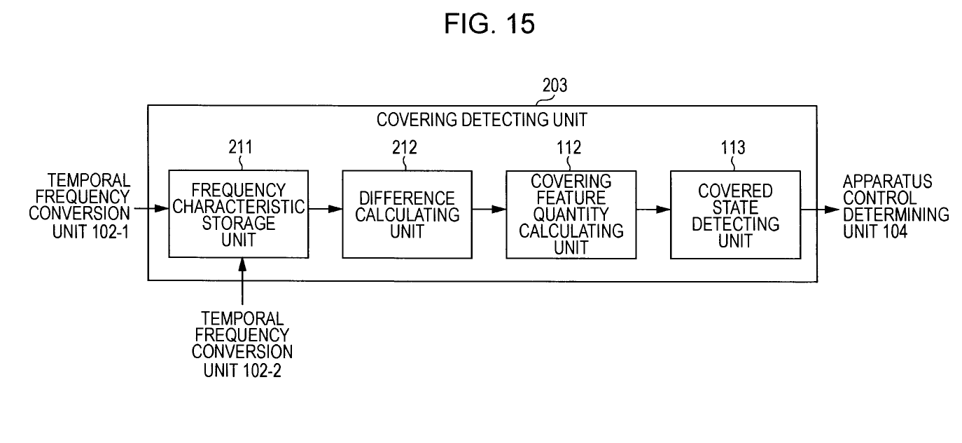

FIG. 15 is a block diagram illustrating an exemplary configuration of the covering detecting unit 203 illustrated in FIG. 14. As illustrated in FIG. 15, the covering detecting unit 203 includes a frequency characteristic storage unit 211 instead of the frequency characteristic storage unit 111 of the covering detecting unit 103, and also includes a difference calculating unit 212 in addition to the covering feature quantity calculating unit 112 and the covered state detecting unit 113.

Like the frequency characteristic storage unit 111, the frequency characteristic storage unit 211 includes an arbitrary storage medium, such as a hard disk, a flash memory, or a RAM, and stores the frequency characteristic (power spectrum) of the input sound supplied from the temporal frequency conversion unit 102-1 and the frequency characteristic (power spectrum) of the input sound supplied from the temporal frequency conversion unit 102-2. The frequency characteristic storage unit 211 supplies both the power spectra stored therein to the difference calculating unit 212 at a certain timing or in response to a request from the difference calculating unit 212.

The difference calculating unit 212 calculates the difference between the power spectrum of the acoustic signal collected by the acoustic signal input unit 101-1 and the power spectrum of the acoustic signal collected by the acoustic signal input unit 101-2, the power spectra being supplied from the frequency characteristic storage unit 211.

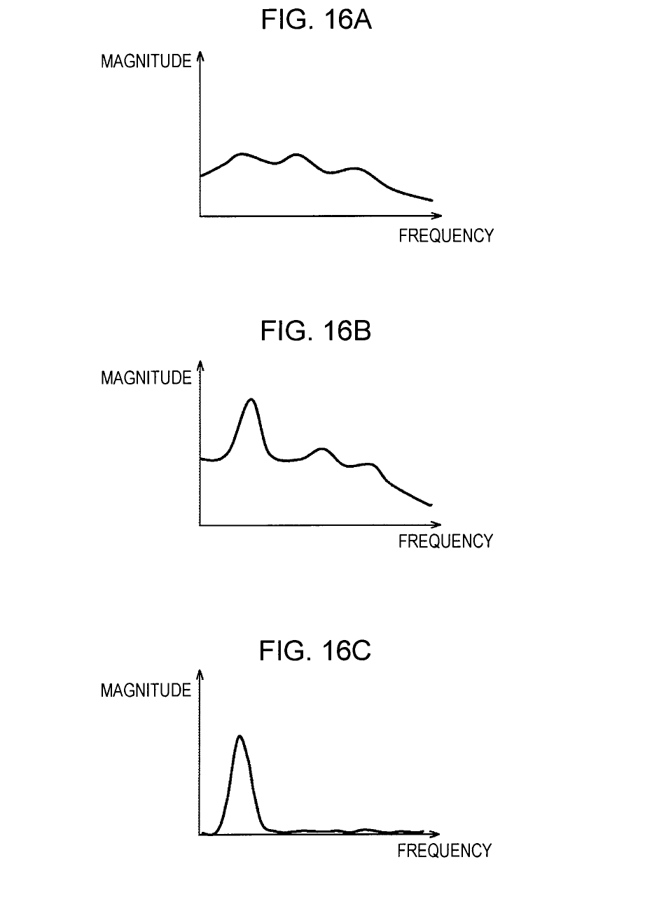

For example, when a user covers only the acoustic signal input unit 101-2 with his/her hand or the like, the power spectrum of the input sound input through the acoustic signal input unit 101-1 has a spectrum waveform of a non-covered state, as illustrated in FIG. 16A. On the other hand, the power spectrum of the input sound input through the acoustic signal input unit 101-2 has a spectrum waveform of a covered state, and a peak (resonance point) is observed, as illustrated in FIG. 16B.

However, if a spectrum exists in the frequency components other than the frequency component of a peak, as illustrated in FIG. 16A, for example, the peak may be indistinctive, as illustrated in FIG. 16B.

The difference calculating unit 212 calculates the difference between these spectra, thereby obtaining a spectrum waveform illustrated in FIG. 16C. As described above, the input sound of the acoustic signal input unit 101-1 and the input sound of the acoustic signal input unit 101-2 are substantially the same in a non-covered state. That is, by subtracting the spectrum in a state where the acoustic signal input unit 101 is not covered from the spectrum in a state where the acoustic signal input unit 101 is covered, the change caused by covering the acoustic signal input unit 101, that is, the spectrum at the peak, is emphasized.

The difference calculating unit 212 supplies the difference value calculated in this manner to the covering feature quantity calculating unit 112. The covering feature quantity calculating unit 112 calculates a covering feature quantity regarding the peak (resonance point) on the basis of the difference value.

In this way, the covering feature quantity calculating unit 112 is capable of specifying a peak (resonance point) more accurately. That is, the covering feature quantity calculating unit 112 is capable of calculating a covering feature quantity regarding a peak (resonance point) more accurately. Accordingly, the covered state detecting unit 113 is capable of determining a covered state and generating covered state information more accurately. That is, the control device 200 is capable of realizing a voiceless and noncontact input operation. Furthermore, the control device 200 is capable of outputting control information corresponding to a user operation more accurately.

The number of acoustic signal input units 101 is not limited, and may be three or more, for example. Also, the positional relationship among a plurality of acoustic signal input units 101 is not limited as long as the individual acoustic signal input units 101 are capable of receiving substantially the same sound in a non-covered state and are placed at a distance from one another so that a user or the like can cover each of them separately. For example, a plurality of acoustic signal input units 101 may be arranged in a matrix at certain intervals.

Alternatively, the plurality of acoustic signal input units 101 may be arranged in orientations different from one another.

### Control Process

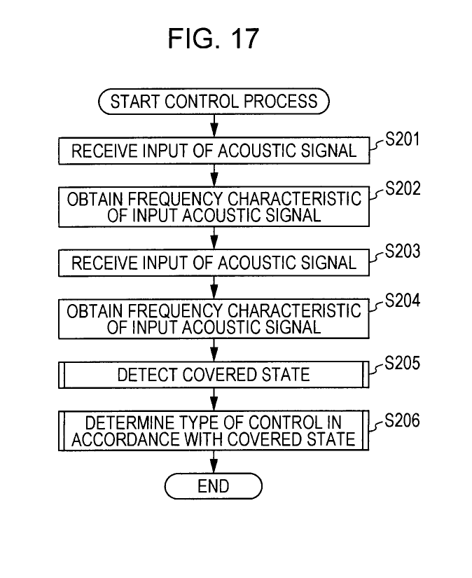

An example of the procedure of a control process in this case will be described with reference to the flowchart illustrated in FIG. 17. This flowchart corresponds to the flowchart illustrated in FIG. 11.

The control process performed by the control device 200 is basically similar to the control process performed by the control device 100 (FIG. 11).

However, in the example illustrated in FIG. 17, the frequency characteristic (power spectrum) of an acoustic signal collected by the acoustic signal input unit 101-1 is generated in steps S201 and S202. Also, the frequency characteristic (power spectrum) of an acoustic signal collected by the acoustic signal input unit 101-2 is generated in steps S203 and S204.

The method for generating these power spectra is similar to the method used in steps S101 and S102 in FIG. 11. That is, the process in steps S101 and S102 in FIG. 11 is repeated the number of times corresponding to the number of acoustic signal input units 101. For example, in a case where the number of acoustic signal input units 101 is three or more, the process in steps S101 and S102 in FIG. 11 is repeated three times or more (the process in steps S101 and S102 in FIG. 11 is performed for each acoustic signal input unit 101).

In step S205, the covering detecting unit 203 detects a covered state, and generates covered state information on the basis of the power spectra generated through the process in steps S201 to S204. In step S206, the apparatus control determining unit 104 determines the type of control to be performed in accordance with the covered state on the basis of the covered state information generated in step S205, as in step S104 in FIG. 11.

After step S206, the control device 200 ends the control process. The control device 200 repeatedly performs such a control process. Actually, the individual steps in the control process are appropriately performed in parallel.

### Procedure of Covered State Detection Process

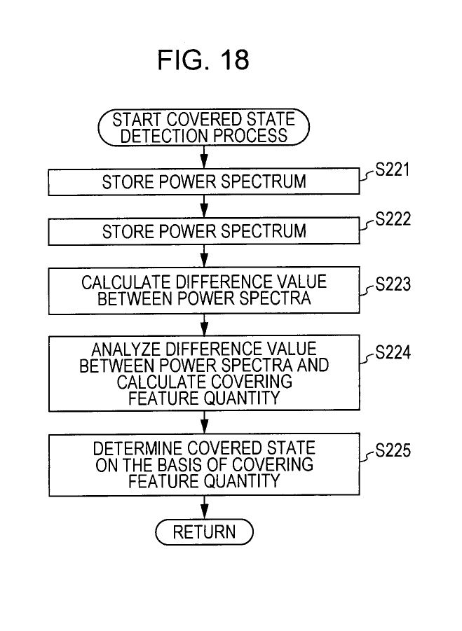

Next, an example of the procedure of the covered state detection process performed by the covering detecting unit 203 in step S205 in FIG. 17 will be described with reference to the flowchart illustrated in FIG. 18. This flowchart corresponds to the flowchart illustrated in FIG. 12.

After the covered state detection process has started, in step S221, the frequency characteristic storage unit 211 stores the power spectrum of the input sound of the acoustic signal input unit 101-1 calculated in step S202 in FIG. 17. In step S222, the frequency characteristic storage unit 211 stores the power spectrum of the input sound of the acoustic signal input unit 101-2 calculated in step S204 in FIG. 17.

In step S223, the difference calculating unit 212 calculates a difference value between the power spectra stored in steps S221 and S222. In step S224, the covering feature quantity calculating unit 112 analyzes the difference value between the power spectra calculated in step S223, and calculates a covering feature quantity, as in step S122 in FIG. 12.

In a case where the covering feature quantity calculating unit 112 calculates a covering feature quantity using only the power spectrum of single sampling in step S224, steps S221 and S222 may be skipped, and step S223 may be performed just after the power spectrum is calculated in step S204 in FIG. 17. Also, in a case where the covering feature quantity calculating unit 112 calculates a covering feature quantity using the power spectra of a plurality of samplings in step S224, step S223 may be performed after the process in steps S221 and S222 has been performed a certain number of times (a plurality of times).

In step S225, the covered state detecting unit 113 determines the covered state of each acoustic signal input unit 101 (the type of user operation) on the basis of the covering feature quantity calculated in step S224, and outputs covered state information representing the covered state to the apparatus control determining unit 104, as in step S123 in FIG. 12.

After step S225, the covering detecting unit 203 ends the covered state detection process, the process returns to step S205 in FIG. 17, and the process is performed from step S206.

By performing the above-described processes, the control device 200 is capable of realizing a voiceless and noncontact input operation, and outputting control information corresponding to a user operation more accurately.

The above-described control device 100 and control device 200 may be used as a control device of an arbitrary electronic apparatus. Also, the control device 100 and control device 200 may be used as a control unit of an arbitrary electronic apparatus.

Some of application examples of the control device 100 and control device 200 will be described below.

### 3. Third Embodiment

### Portable Music Player

Hereinafter, the case of applying the control device 100 to a portable music player will be described.

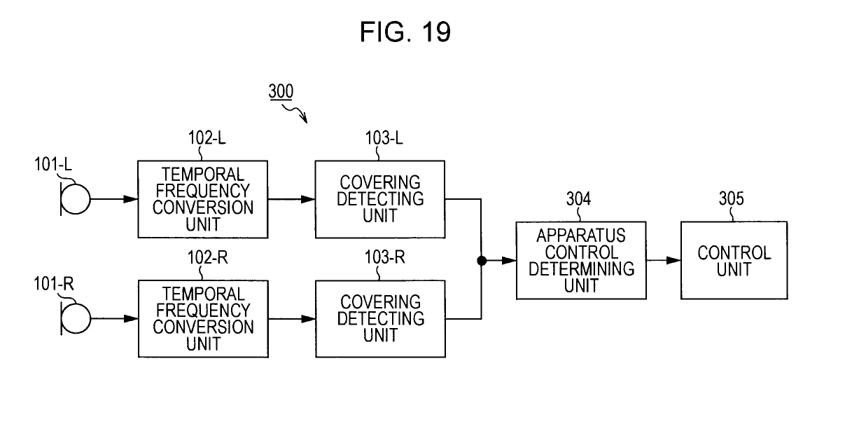

FIG. 19 is a block diagram illustrating an exemplary configuration of a portable music player 300 according to a third embodiment of the present disclosure. FIG. 19 illustrates the part related to this embodiment. The portable music player 300 illustrated in FIG. 19 plays back song data stored in an arbitrary storage medium, such as a hard disk or a flash memory, and outputs played back acoustic signals through a speaker, such as a headphone.

The portable music player 300 includes the control device 100. Thus, the user of the portable music player 300 can input an instruction about control, such as an instruction to play back song data, by performing a voiceless and noncontact operation.

As illustrated in FIG. 19, the portable music player 300 includes an acoustic signal input unit 101-L, a temporal frequency conversion unit 102-L, a covering detecting unit 103-L, an acoustic signal input unit 101-R, a temporal frequency conversion unit 102-R, a covering detecting unit 103-R, an apparatus control determining unit 304, and a control unit 305.

Each of the acoustic signal input units 101-L and 101-R corresponds to the acoustic signal input unit 101. Each of the temporal frequency conversion units 102-L and 102-R corresponds to the temporal frequency conversion unit 102. Each of the covering detecting units 103-L and 103-R corresponds to the covering detecting unit 103.

The acoustic signal input units 101-L and 101-R are provided as different input units at different positions. That is, the acoustic signal input units 101-L and 101-R are not configured to calculate a difference value between spectra, unlike in the control device 200, but operate independently from each other and receive a user operation performed thereon.

The temporal frequency conversion unit 102-L and the covering detecting unit 103-L perform a process on an electric signal generated by converting the input sound input to the acoustic signal input unit 101-L. The temporal frequency conversion unit 102-R and the covering detecting unit 103-R perform a process on an electric signal generated by converting the input sound input to the acoustic signal input unit 101-R.

That is, the portable music player 300 has two input systems for “R” and “L”. The individual input systems operate independently from each other, but different types of control are assigned to the input systems. In other words, when the user covers each of the acoustic signal input units 101-L and 101-R in the same manner, the types of control to be determined for them are different from each other.

The setting positions of the acoustic signal input units 101-L and 101-R are not limited. For example, the acoustic signal input unit 101-L may be provided near a left speaker of a headphone by being oriented toward the outside of the headphone (at the position opposite to the user's head in a state where the headphone is put on the head). Also, for example, the acoustic signal input unit 101-R may be provided near a right speaker of the headphone by being oriented toward the outside of the headphone (at the position opposite to the user's head in a state where the headphone is put on the head).

For example, when the user covers the acoustic signal input unit 101-L with his/her hand, the covering detecting unit 103-L detects the covered state, generates covered state information, and supplies the covered state information to the apparatus control determining unit 304, as in the first embodiment.

Likewise, for example, when the user covers the acoustic signal input unit 101-R with his/her hand, the covering detecting unit 103-R detects the covered state, generates covered state information, and supplies the covered state information to the apparatus control determining unit 304, as in the first embodiment.

As described above, different types of control are assigned to the individual input systems. The apparatus control determining unit 304 determines the type of control to be performed on the basis of individual pieces of covered state information. The apparatus control determining unit 304 has a configuration similar to that of the apparatus control determining unit 104. That is, the apparatus control determining unit 304 includes the covered state storage unit 161 and the type-of-control determining unit 162 (FIG. 8).

Hereinafter, a specific example of the state of determining the type of control will be described.

For example, the value of covered state information output from the covering detecting unit 103-L at time t is represented by X_Lch[t]. When the acoustic signal input unit 101-L is covered, X_Lch[t]=1. When the acoustic signal input unit 101-L is not covered, X_Lch[t]=−1.

If the state of the acoustic signal input unit 101-L changes from a non-covered state to a covered state due to a user operation or the like, that is, if the value of covered state information changes from X_Lch[t1−1]=−1 to X_Lch[t1]=1, the apparatus control determining unit 304 waits until the state of the acoustic signal input unit 101-L changes from a covered state to a non-covered state, that is, until the value of covered state information changes from X_Lch[t2−1]=1 to X_Lch[t2]=−1.

Then, if the state of the acoustic signal input unit 101-L changes from a covered state to a non-covered state, that is, if the value of covered state information changes from X_Lch[t2−1]=1 to X_Lch[t2]=−1, the apparatus control determining unit 304 determines the interval between time t2 and time t1 (t2−t1). If t2−t1<T, the apparatus control determining unit 304 generates and outputs control information for selecting the preceding song. If t2−t1≧T, the apparatus control determining unit 304 generates and outputs control information for fast-reversing the song that is currently being played back.

In contrast, for example, the value of covered state information output from the covering detecting unit 103-R at time t is represented by X_Rch[t]. When the acoustic signal input unit 101-R is covered, X_Rch[t]=1. When the acoustic signal input unit 101-R is not covered, X_Rch[t]=−1.

If the state of the acoustic signal input unit 101-R changes from a non-covered state to a covered state due to a user operation or the like, that is, if the value of covered state information changes from X_Rch[t1−1]=−1 to X_Rch[t1]=1, the apparatus control determining unit 304 waits until the state of the acoustic signal input unit 101-R changes from a covered state to a non-covered state, that is, until the value of covered state information changes from X_Rch[t2−1]=1 to X_Rch[t2]=−1.

Then, if the state of the acoustic signal input unit 101-R changes from a covered state to a non-covered state, that is, if the value of covered state information changes from X_Rch[t2−1]=1 to X_Rch[t2]=−1, the apparatus control determining unit 304 determines the interval between time t2 and time t1 (t2−t1). If t2−t1<T, the apparatus control determining unit 304 generates and outputs control information for selecting the next song. If t2−t1≧T, the apparatus control determining unit 304 generates and outputs control information for fast-forwarding the song that is currently being played back.

The apparatus control determining unit 304 determines the type of control in this way, and supplies control information to the control unit 305. The control unit 305 controls the operation of the portable music player 300 in accordance with the control information supplied from the apparatus control determining unit 304. For example, in the above-described example, the control unit 305 controls playback operations, such as selection of a song, fast-reversing, and fast-forwarding, on the basis of the control information. Of course, the type of control may be arbitrarily determined. For example, the volume of output sound, editing of song data, and the setting of audio processing (equalizing) may be controlled.

As described above, with the use of the control device 100, the portable music player 300 enables the user to input an instruction regarding the control of playing back song data or the like by performing a voiceless and noncontact operation.

For example, the user can easily select a song and perform fast-forwarding and fast-reversing operations on song data by covering, with his/her hand, any one of the acoustic signal input units 101-L and 101-R provided near the speakers on the right and on the left of the headphone.

Also, as described above, the portable music player 300 has a plurality of acoustic signal input units 101 for realizing multiple input systems, and thus enables the user to input more various control instructions more easily.

### Procedure of Control Process

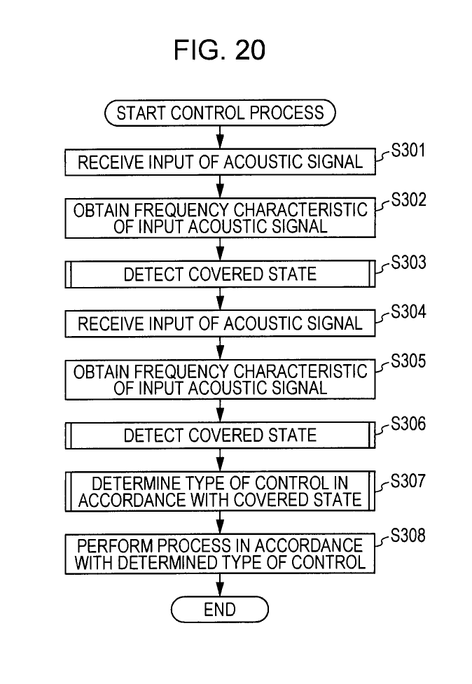

An example of the procedure of a control process in this case will be described with reference to the flowchart illustrated in FIG. 20. In this control process, a process that is basically similar to the control process according to the first embodiment (FIG. 11) is performed.

However, in this case, a plurality of (two) input systems exist, and thus the process from step S101 to step S103 is performed for each of the input systems. In the example illustrated in FIG. 20, a process from step S301 to step S303, which is similar to the process from step S101 to step S103, is performed for the L input system, and then a process from step S304 to step S306, which is similar to the process from step S101 to step S103, is performed for the R input system.

In step S307, the apparatus control determining unit 304 performs a type-of-control determination process on the basis of the pieces of covered state information generated in step S303 and step S306, respectively. In step S308, the control unit 305 performs a process in accordance with the type of control determined in step S307, and ends the control process.

The control process is repeatedly performed. Also, the individual steps are appropriately performed in parallel.

### Procedure of Type-of-Control Determination Process

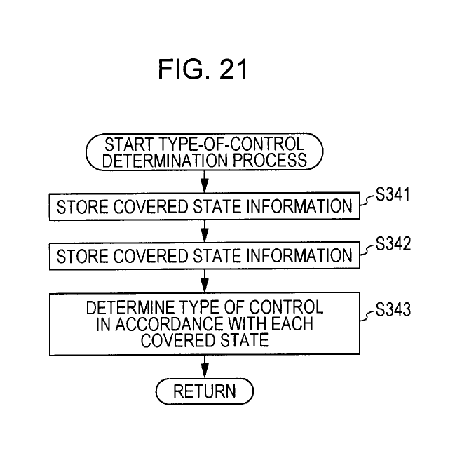

Next, an example of the procedure of the type-of-control determination process performed in step S307 in FIG. 20 will be described with reference to the flowchart illustrated in FIG. 21.

After the type-of-control determination process has started, the covered state storage unit 161 stores the covered state information supplied from the covering detecting unit 103-L in step S341, and stores the covered state information supplied from the covering detecting unit 103-R in step S342.

In step S343, the type-of-control determining unit 162 determines the type of control to be performed on the basis of the pieces of covered state information about the individual systems (i.e., the covered states of the acoustic signal input units 101-L and 101-R) stored in the covered state storage unit 161.

After the type of control has been determined, the apparatus control determining unit 304 ends the type-of-control determination process, the process returns to step S307 in FIG. 20, and the process is performed from step S308.

By performing the individual processes in the above-described manner, the portable music player 300 enables the user to input more various control instructions more easily.

In the above-described example, the number of input systems is two. Of course, the number of input systems may be three or more. In that case, the user can input more control instructions more easily.

In the above-described example, the control device 100 is used in the portable music player 300. Of course, the control device 200 may be used instead of the control device 100. In that case, each of the acoustic signal input units 101-L and 101-R is constituted by the two acoustic signal input units 101-1 and 101-2, as described above with reference to FIGS. 14 to 18. Each of the covering detecting units 103-L and 103-R generates covered state information on the basis of difference information about spectra.

The control devices 100 and 200 according to the first and second embodiments of the present disclosure may be used for an electronic apparatus other than the portable music player 300, for example, a game machine.

Game machines available in recent years often have a game controller provided with a microphone. The acoustic signal input unit 101 may be used as the microphone. For example, by using the distance between the microphone and something covering the microphone (for example, hand) and the coverage as parameters, and by reflecting the parameters in a game, the microphone can be used as a so-called analog controller to which the amount of control can be input in game operations.

### 4. Fourth Embodiment

### Mobile Phone

The case of applying the control device 100 to a mobile phone will be described.

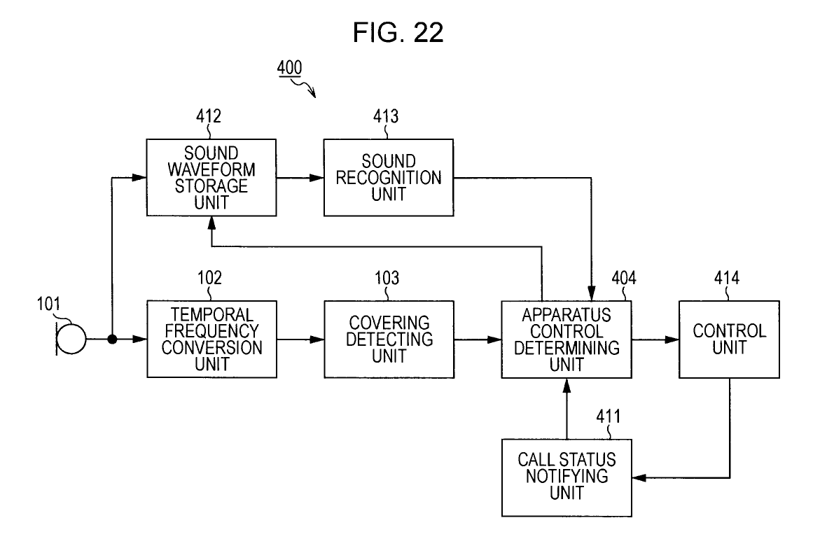

FIG. 22 is a block diagram illustrating an exemplary configuration of a mobile phone 400 according to a fourth embodiment of the present disclosure. FIG. 22 illustrates only the part related to this embodiment. In the mobile phone 400 illustrated in FIG. 22, the acoustic signal input unit 101 is also used as a microphone that is used for a call. The microphone is also used as an input device for a sound recognition process.

As illustrated in FIG. 22, the mobile phone 400 includes, for example, the acoustic signal input unit 101, the temporal frequency conversion unit 102, the covering detecting unit 103, an apparatus control determining unit 404, a call status notifying unit 411, a sound waveform storage unit 412, a sound recognition unit 413, and a control unit 414.

The apparatus control determining unit 404 has a configuration similar to that of the apparatus control determining unit 104 (FIG. 8). That is, the apparatus control determining unit 404 includes the covered state storage unit 161 and the type-of-control determining unit 162.

The apparatus control determining unit 404 determines the type of control to be performed on the basis of covered state information supplied from the covering detecting unit 103. At this time, the apparatus control determining unit 404 also refers to information about a call status supplied from the call status notifying unit 411.

For example, the value of covered state information output from the covering detecting unit 103 at certain time t is represented by X[t]. When the acoustic signal input unit 101 is covered, X[t]=1. When the acoustic signal input unit 101 is not covered, X[t]=−1.

If the state of the acoustic signal input unit 101 changes from a non-covered state to a covered state, that is, if the value of covered state information changes from X[t1−1]=−1 to X[t1]=1, the apparatus control determining unit 404 waits until the state of the acoustic signal input unit 101 changes from a covered state to a non-covered state, that is, until the value of covered state information changes from X[t2−1]=1 to X[t2]=−1.

Then, the apparatus control determining unit 404 compares time t1 with time t2. If the difference (t2−t1) is longer than a certain time threshold T (t2−t1>T) and if the call status of the mobile phone 400 is active, the apparatus control determining unit 404 determines the type of control to increase the volume of receiving sound, and supplies control information about the determined type of control to the control unit 414.

For example, if a user puts his/her hand near the microphone (acoustic signal input unit 101) of the mobile phone 400 (near his/her mouth) during call, the mobile phone 400 increases the volume of receiving sound (the output level of the speaker).

In contrast, if the difference (t2−t1) is longer than the certain time threshold T (t2−t1>T) and if the call status of the mobile phone 400 is inactive, the apparatus control determining unit 404 determines the type of control so that the electric signal of sound input from time t1 to time t2 is supplied to the sound recognition unit 413 and that a sound recognition process is performed, and supplies control information about the determined type of control to the sound waveform storage unit 412.

Then, the apparatus control determining unit 404 obtains a sound recognition result from the sound recognition unit 413, and supplies, to the control unit 414, control information for providing an instruction to perform a process in accordance with the sound recognition result.

For example, if the user inputs sound while putting his/her hand near the microphone (the acoustic signal input unit 101) of the mobile phone 400 (near his/her mouth) when the call status is inactive, the mobile phone 400 performs a process in accordance with the input sound.

Of course, the type of control determined in accordance with each covered state is not limited.

The call status notifying unit 411 recognizes the call status of the mobile phone 400 on the basis of the control state of the control unit 414, and notifies the apparatus control determining unit 404 of the call status. The apparatus control determining unit 404 determines whether or not the call status of the mobile phone 400 is active on the basis of the notification.

The sound waveform storage unit 412 is constituted by an arbitrary storage medium, such as a hard disk, a flash memory, or a RAM, and stores the electric signal of the input sound input to the acoustic signal input unit 101 for a certain period. The sound waveform storage unit 412 supplies the electric signal stored therein to the sound recognition unit 413 in accordance with the control performed by the apparatus control determining unit 404.

The sound recognition unit 413 analyzes the electric signal supplied from the sound waveform storage unit 412, and performs a sound recognition process. The method of the sound recognition process is not limited. The sound recognition unit 413 supplies a sound recognition result to the apparatus control determining unit 404.

The control unit 414 controls the individual units of the mobile phone 400 on the basis of the control information supplied from the apparatus control determining unit 404. The type of control is not limited, and control other than the above-described control may be performed.

As described above, with the use of the control device 100, the mobile phone 400 enables the user to input an instruction about control of the mobile phone 400 by performing a voiceless and noncontact operation.

Also, as described above, by using the acoustic signal input unit 101 as the microphone used for call in the mobile phone 400, the number of components can be reduced, and the cost of manufacturing the mobile phone 400 can be decreased.

Furthermore, as described above, the acoustic signal input unit 101 may also be used as an input unit for another process, such as a sound recognition process. Accordingly, the cost of the mobile phone 400 can be further decreased.

### Procedure of Control Process

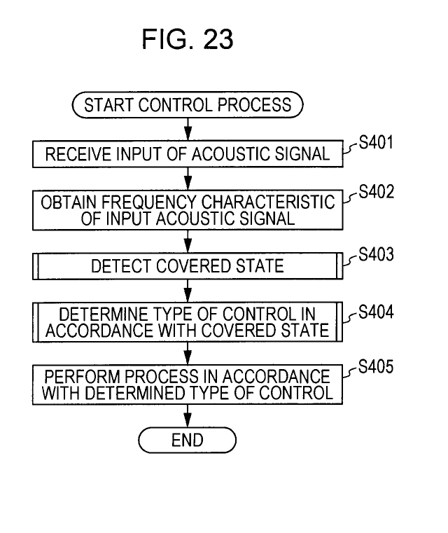

An example of the procedure of a control process in this case will be described with reference to the flowchart illustrated in FIG. 23.

In this case, as illustrated in FIG. 23, the control process is performed basically similarly to the control process described above with reference to FIG. 11. That is, the process from step S401 to step S404 is performed basically similarly to the process from step S101 to step S104 in FIG. 11.

The details of the type-of-control determination process performed in step S404 will be described below.

In step S405, the control unit 414 controls the individual units of the mobile phone 400, performs a process in accordance with the type of control determined by the apparatus control determining unit 404, and ends the control process.

The control process is repeatedly performed also in this case. The individual steps are appropriately performed in parallel.

### Procedure of Type-of-Control Determination Process

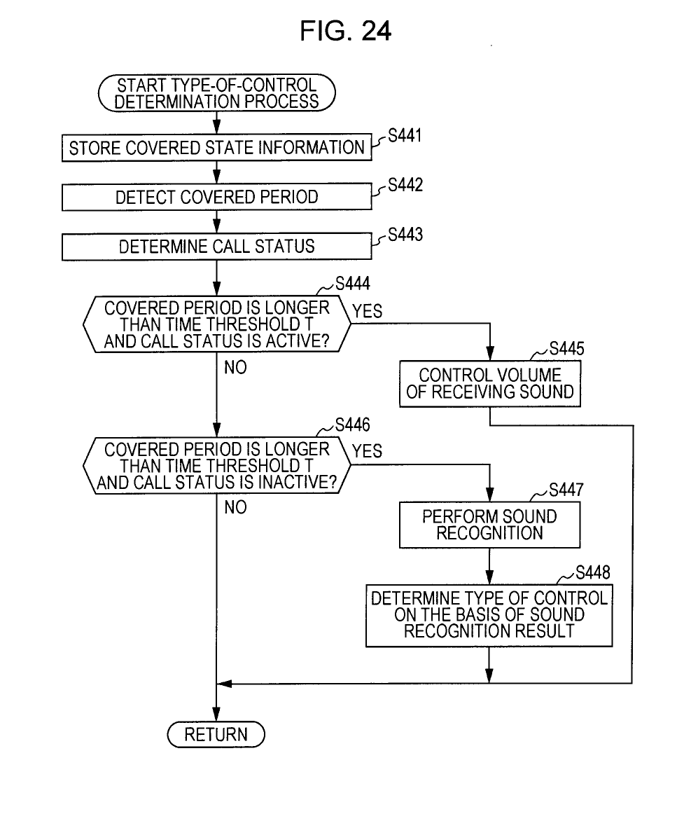

Next, an example of the procedure of the type-of-control determination process performed in step S404 in FIG. 23 will be described with reference to the flowchart illustrated in FIG. 24.

After the type-of-control determination process has started, in step S441, the covered state storage unit 161 stores covered state information supplied from the covering detecting unit 103.

In step S442, the type-of-control determining unit 162 detects a covered period (for example, the above-described t2−t1), which is a period over which the acoustic signal input unit 101 is covered with a user's hand or the like, on the basis of the covered state information stored in the covered state storage unit 161.

In step S443, the type-of-control determining unit 162 determines the call status on the basis of a notification from the call status notifying unit 411.

In step S444, the type-of-control determining unit 162 determines whether or not the covered period is longer than a certain period (time threshold T) and whether or not the call status is active on the basis of the process results of steps S442 and S443. If it is determined that the covered period is longer than the certain period (time threshold T) and that the call status is in active, the type-of-control determining unit 162 proceeds to step S445.

In step S445, the type-of-control determining unit 162 supplies control information to the control unit 414 and causes the control unit 414 to reduce the volume of receiving sound. After step S445, the type-of-control determining unit 162 ends the type-of-control determination process, the process returns to step S404 in FIG. 23, and the process is performed from step S405.

If it is determined in step S444 in FIG. 24 that the covered period is not longer than the certain period (time threshold T) or that the call status is inactive, the type-of-control determining unit 162 proceeds to step S446.

In step S446, the type-of-control determining unit 162 determines whether or not the covered period is longer than the certain period (time threshold T) and whether or not the call status is inactive on the basis of the process results of steps S442 and S443. If it is determined that the covered period is longer than the certain period (time threshold T) and that the call status is inactive, the type-of-control determining unit 162 proceeds to step S447.

In step S447, the type-of-control determining unit 162 controls the sound waveform storage unit 412 to supply the electric signal of the input sound in the covered period stored in the sound waveform storage unit 412 to the sound recognition unit 413, and causes the sound recognition unit 413 to perform sound recognition.

In step S448, the type-of-control determining unit 162 determines the type of control on the basis of the sound recognition result, supplies control information to the control unit 414, and causes the control unit 414 to perform control so that a process corresponding to the sound recognition process is performed. After step S448, the type-of-control determining unit 162 ends the type-of-control determination process, the process returns to step S404 in FIG. 23, and the process is performed from step S405.

If it is determined in step S446 in FIG. 24 that the covered period is not longer than the certain period (time threshold T), the type-of-control determining unit 162 ends the type-of-control determination process, the process returns to step S404 in FIG. 23, and the process is performed from step S405.

By performing the above-described processes, the mobile phone 400 enables the user to input an instruction to control the mobile phone 400 by performing a voiceless and noncontact operation.

In the above-described example, the control device 100 is used in the mobile phone 400. Alternatively, the control device 200 may be used instead of the control device 100.

The control devices 100 and 200 according to the first and second embodiments of the present disclosure may be applied to electronic apparatuses other than a mobile phone, for example, a sound recognition apparatus and an IC recorder.

For example, in typical sound recognition apparatuses that are currently available, a method called “push-to-talk” is often used, in which the period of sound to be recognized is specified using a certain method. In this method, a user presses a button or the like before talking.

By using the control device 100 or the control device 200 instead of this button, an operation of pressing a button may be replaced by a noncontact operation, in which the user covers a microphone for speaking with his/her hand. Accordingly, it is not necessary to provide a button for push-to-talk, and the cost of manufacturing a sound recognition apparatus can be reduced.

In this case, it is not necessary for the user to touch the microphone with his/her hand. Thus, the user can talk while covering the microphone with his/her hand or the like (also in this state, the microphone is capable of adequately collecting the voice of the user).

In contrast, when it is necessary to touch the microphone, for example, by tapping the microphone with a finger, for example, it is necessary to move the hand off the microphone before talking, which is inconvenient. Also, noise is generated by the touch. Thus, it may be difficult to collect sound at the start of talking in a preferred state with low noise, and the accuracy of a sound recognition process may be degraded.

With the application of the embodiments of the present disclosure, a noncontact operation is realized. Thus, a sound recognition apparatus is capable of collecting sound in a preferred state with low noise from the start of talking.

Furthermore, the control device 100 or the control device 200 according to the embodiments of the present disclosure may be applied to an IC recorder. In that case, the acoustic signal input unit 101 may be used as a microphone that is used for correcting (recording) sound provided in the IC recorder.

For example, if the microphone is covered for a short period, recording may be suspended. If the microphone is covered for a long period, recording may be suspended if recording is being performed, or recording may be started if recording is suspended.

In this way, operations regarding the IC recorder are assigned as types of control to covered states. Accordingly, the user can operate the IC recorder without touching the body of the IC recorder. Thus, as in the case of the sound recognition apparatus, the cost of manufacturing can be decreased. Furthermore, recording of noise caused by touching the microphone or the like by the user can be suppressed.

Of course, the control devices according to the embodiments of the present disclosure can be applied to arbitrary electronic apparatuses other than the above-described apparatuses.

### 5. Fifth Embodiment

### Personal Computer

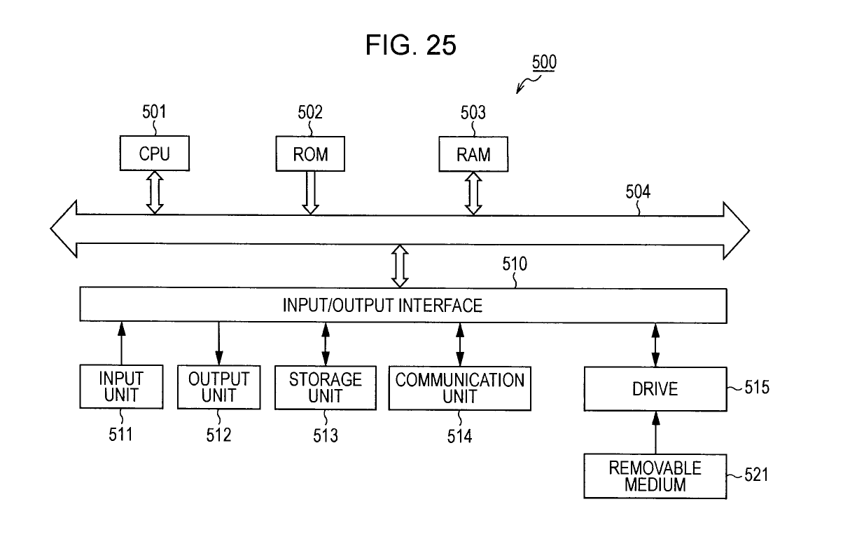

The series of above-described processes can be performed by using hardware or software. In this case, the configuration of a personal computer 500 illustrated in FIG. 25 may be used, for example.

Referring to FIG. 25, a central processing unit (CPU) 501 of the personal computer 500 performs various processes in accordance with a program stored in a read only memory (ROM) 502 or a program loaded from a storage unit 513 to a random access memory (RAM) 503. Also, data necessary for the CPU 501 to perform various processes is appropriately stored in the RAM 503.

The CPU 501, the ROM 502, and the RAM 503 are connected to one another via a bus 504. Also, an input/output interface 510 is connected to the bus 504.

An input unit 511, an output unit 512, a storage unit 513, and a communication unit 514 are connected to the input/output interface 510. The input unit 511 includes a keyboard and a mouse. The output unit 512 includes a display, such as a cathode ray tube (CRT) display or a liquid crystal display (LCD), and a speaker. The storage unit 513 includes a solid state drive (SSD), such as a flash memory, and a hard disk. The communication unit 514 includes an interface and modem for a wired local area network (LAN) or a wireless LAN, and performs a communication process via a network, such as the Internet.

Also, a drive 515 is connected to the input/output interface 510 if necessary. A removable medium 521, such as a magnetic disk, an optical disc, a magneto-optical disc, or a semiconductor memory, is loaded into the drive 515 if necessary. A computer program read from the removable medium 521 is installed into the storage unit 513 if necessary.

In the case of performing the series of above-described processes using software, the program constituting the software is installed via a network or a recording medium.

The recording medium may be the removable medium 521 illustrated in FIG. 25, which is separated from the body of the apparatus and is distributed to distribute the program to a user, for example, a magnetic disk (including a flexible disk), an optical disc (including a compact disc-read only memory (CD-ROM) and a digital versatile disc (DVD)), a magneto-optical disc (including a Mini Disc (MD)), or a semiconductor memory having the program recorded thereon. Alternatively, the recording medium may be the ROM 502 or the hard disk included in the storage unit 513 that is provided to a user in the state of being incorporated into the body of the apparatus and that has the program recorded thereon.

The program executed by the computer may be a program in which processes are performed in time series in accordance with the order described in this specification, or a program in which processes are performed in parallel or at necessary timings at which the individual processes are called.

The steps included in the program recorded on a recording medium in this specification may be performed in time series in accordance with the described order, or may be performed in parallel or individually.

A configuration described above as a single device (or a single processing unit) may be constituted by a plurality of devices (or processing units). Also, a configuration described above as a plurality of devices (or processing units) may be constituted by a single device (or a single processing unit). Also, a configuration other than the above-described configurations may be added to the configuration of each device (or processing unit). Furthermore, part of the configuration of a certain device (or processing unit) may be included in another device (or another processing unit) as long as the configuration and operation of an entire apparatus are substantially the same. That is, the embodiments of the present disclosure are not limited to the above-described embodiments, and various modifications may be made without deviating from the gist of the present disclosure.

The present disclosure contains subject matter related to that disclosed in Japanese Priority Patent Application JP 2011-016398 filed in the Japan Patent Office on Jan. 28, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a sound collecting unit configured to collect sound;
a covering detecting unit configured to detect a covered state of the sound collecting unit on the basis of a resonance frequency and a magnitude of a component of the resonance frequency in a frequency characteristic of an acoustic signal obtained through sound collection performed by the sound collecting unit; and
an apparatus control determining unit configured to determine a type of control to be performed on a target apparatus in accordance with the covered state of the sound collecting unit detected by the covering detecting unit.

2. The signal processing device according to claim 1,
wherein the covering detecting unit detects whether or not the sound collecting unit is covered, or detects a degree to which the sound collecting unit is covered.

3. The signal processing device according to claim 1,
wherein the covering detecting unit compares the resonance frequency with a certain threshold and compares the magnitude of the component of the resonance frequency with a certain threshold, and detects the covered state of the sound collecting unit in accordance with results of the comparisons.

4. The signal processing device according to claim 1,
wherein the covering detecting unit adds resonance frequencies and magnitudes of components of the resonance frequencies in frequency characteristics of the acoustic signal at a plurality of times, and detects the covered state of the sound collecting unit on the basis of a result of the addition.

5. The signal processing device according to claim 1,
wherein the apparatus control determining unit determines the type of control in accordance with whether or not the sound collecting unit is covered or in accordance with a degree to which the sound collecting unit is covered.

6. The signal processing device according to claim 1,
wherein the apparatus control determining unit determines the type of control in accordance with a period over which the sound collecting unit is covered.

7. The signal processing device according to claim 1,
wherein the apparatus control determining unit determines an amount of control for the type of control in accordance with a degree to which the sound collecting unit is covered.

8. The signal processing device according to claim 1,
wherein the sound collecting unit includes a plurality of sound collecting units.

9. The signal processing device according to claim 8, further comprising:
a difference calculating unit configured to calculate a difference in frequency characteristics of acoustic signals obtained by the plurality of sound collecting units,
wherein the covering detecting unit detects the covered states of the plurality of sound collecting units on the basis of the resonance frequency and the magnitude of the component of the resonance frequency in the difference calculated by the difference calculating unit.

10. The signal processing device according to claim 8,
wherein the apparatus control determining unit assigns different types of control to similar covered states of the plurality of sound collecting units.

11. The signal processing device according to claim 1,
wherein the sound collecting unit collects sound for a call process, and
wherein the covering detecting unit detects the covered state of the sound collecting unit on the basis of a resonance frequency and a magnitude of a component of the resonance frequency in a frequency characteristic of an acoustic signal obtained through sound collection performed for the call process by the sound collecting unit.

12. The signal processing device according to claim 1, further comprising:
a sound recognition processing unit configured to perform a sound recognition process on the acoustic signal obtained through sound collection performed by the sound collecting unit,
wherein the apparatus control determining unit determines the type of control in accordance with the covered state of the sound collecting unit detected by the covering detecting unit and a result of the sound recognition process performed by the sound recognition processing unit.

13. A signal processing method for a signal processing device, comprising:
collecting, with a sound collecting unit, sound;
detecting, with a covering detecting unit, a covered state of the sound collecting unit on the basis of a resonance frequency and a magnitude of a component of the resonance frequency in a frequency characteristic of an acoustic signal obtained through sound collection; and
determining, with an apparatus control determining unit, a type of control to be performed on a target apparatus in accordance with the detected covered state of the sound collecting unit.

14. A program that causes a computer to execute a process comprising:
collecting sound;
detecting a covered state of a sound collecting unit on the basis of a resonance frequency and a magnitude of a component of the resonance frequency in a frequency characteristic of an acoustic signal obtained through the collecting sound; and
determining a type of control to be performed on a target apparatus in accordance with the detected covered state of the sound collecting unit.
